(19) United States
(12) Patent Application Publication
(10) Pub. No.: US 2019/0377983 A1
(43) Pub. Date: Dec. 12, 2019

(54) System and Method for Determining and Suggesting Contextually-Related Slide(s) in Slide Suggestions

(71) Applicant: Microsoft Technology Licensing, LLC, Redmond, WA (US)

(72) Inventor: Shyam Sunder VIJAY, Fremont, CA (US)

(73) Assignee: Microsoft Technology Licensing, LLC, Redmond, WA (US)

(21) Appl. No.: 16/005,342

(22) Filed: Jun. 11, 2018

(51) Int. Cl. G06K 9/62; G06N 99/00; G06N 7/00; G06F 17/27

(52) U.S. Cl. CPC G06K 9/6262; G06N 99/005; G06F 17/2785; G06F 17/2775; G06N 7/005

(57) ABSTRACT

Described herein is a system and method for determining contextually-related slide(s). Content and/or semantic structure of a slide is analyzed to determine information regarding the slide. In some embodiments, the slide is analyzed for keyword(s), topic(s), and/or concept(s). A machine learning algorithm is used to identify other slide(s) that are related to the slide in accordance with the determined information. Link(s) to the identified other slide(s) are provided within the slide.

### BACKGROUND

Presentations provide a focal point that allows a presenter to provide narrative information regarding a topic. For example, a presentation can include a plurality of digital slides prepared using an application such as PowerPoint® of Microsoft Corporation.

When it is time for the presenter to give the presentation, the slides can be displayed (e.g., sequentially) while the presenter narrates and/or discusses the content of the slides. For example, the slides can be displayed on a single screen within a physical location viewable by participants and/or displayed on a plurality of screens with each screen viewable by one or more participants (e.g., in physically disparate locations and/or displays of computers in a same or different physical location).

### SUMMARY

Described herein is a system for determining a contextually-related slide, comprising: a computer comprising a processor and a memory having computer-executable instructions stored thereupon which, when executed by the processor, cause the computer to: analyze at least one of content or semantic structure of a slide to determine information regarding the slide; use a machine learning algorithm to identify one or more other slides that are related to the slide in accordance with the determined information; and provide a link to the identified one or more other slides within the slide.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for determining a contextually-related slide.

FIG. 2 is a functional block diagram that illustrates another system for determining a contextually-related slide.

FIGS. 3-7 are exemplary user interfaces.

FIG. 8 is a flow chart of a method of determining a contextually-related slide

FIG. 9 is a functional block diagram that illustrates an exemplary computing system.

### DETAILED DESCRIPTION

Various technologies pertaining to determining contextually-related slide(s) are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding determining contextually-related slide(s). What follows are one or more exemplary systems and methods.

Aspects of the subject disclosure pertain to the technical problem of determining contextually-related slide(s). The technical features associated with addressing this problem involve analyzing at least one of content or semantic structure of a slide to determine information regarding the slide; using a machine learning algorithm to identify one or more other slides that are related to the slide in accordance with the determined information; and providing a link to the identified one or more other slides within the slide. Accordingly, aspects of these technical features exhibit technical effects of more efficiently and effectively determining contextually-related slide(s) thus reducing computer resource(s) and/or increasing user satisfaction.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

“Slide” refers to a unit of information visually and/or audibly digitally presented during a presentation by a presentation application, as discussed in greater detail below.

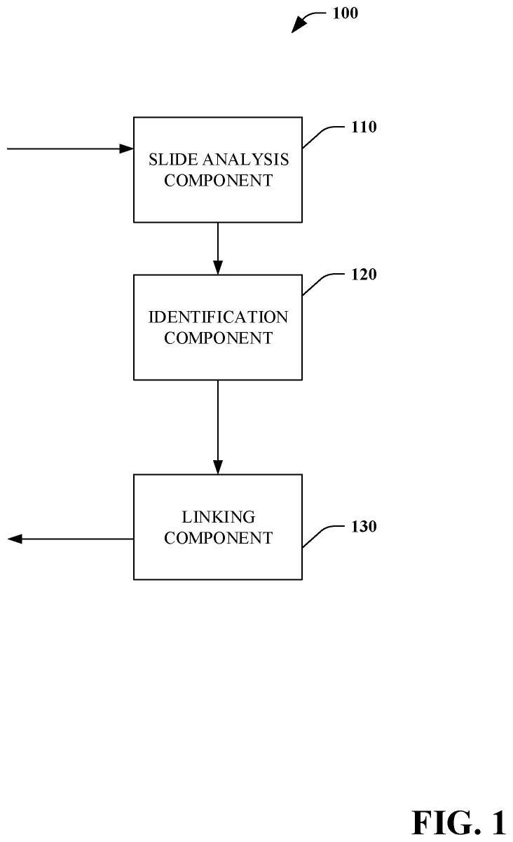

Referring to FIG. 1, a system for determining a contextually-related slide 100 is illustrated. In some embodiments, while a user is reviewing/editing a particular slide of a presentation (e.g., during editing mode), the system 100 can use a machine learning algorithm to identify other slide(s) that are related to the particular slide. In some embodiments, the system 100 can thus identify an association and/or relationship of content of the particular slide and other slide(s). In some embodiments, the use of related slide(s) can allow a presenter to dynamically react in order to provide more (or less) information, for example, based upon audience feedback and/or time requirements.

The system 100 can further provide link(s) to the identified other slide(s) with the particular slide. In some embodiments, when the particular slide is being presented (e.g., during presentation mode), selection/activation of a particular link (e.g., embedded in the particular slide) can cause the identified other slide to be presented (e.g., slide zoom). A transition animation can be utilized for transition from the particular slide to the identified other slide and/or vice versa.

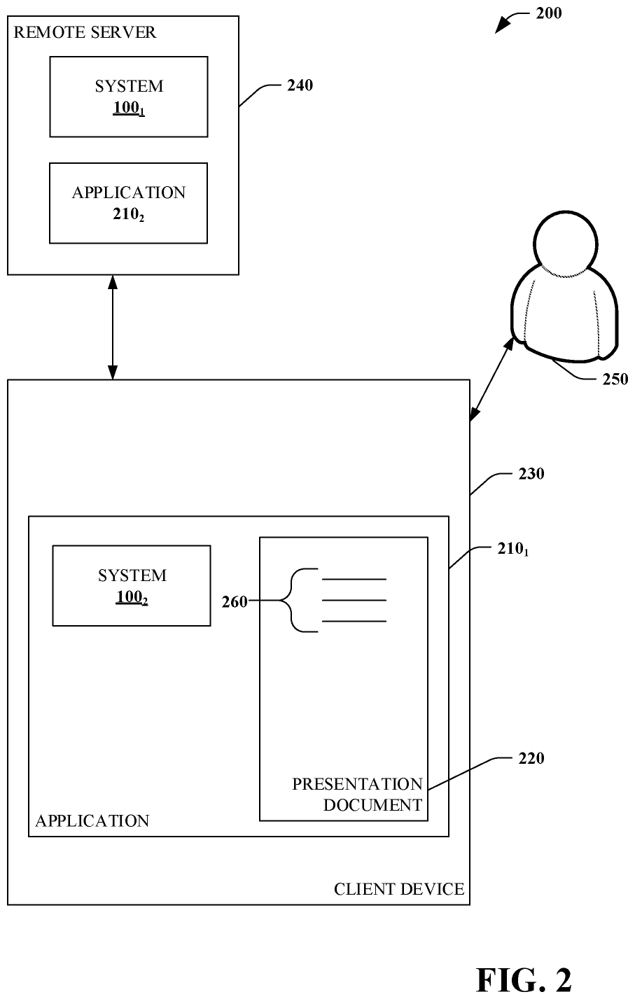

Turning briefly to FIG. 2, a system for determining contextually-related slides 200 is illustrated. The system 200 includes an application 210₁, 210₂ (generally, 210) used to view, generate, and/or edit a presentation document 220. Examples of suitable applications 210 include, but are not limited to, word processing, spreadsheet, database, slide presentation, electronic mail, drawing, note taking, web browser, media player, and game applications.

In some embodiments, the application 210₁ is a thick client application stored locally on a client device 230. In some embodiments, the application 210₂ is a thin client application (i.e., web applications) that resides on a remote server 240 and accessible over a network or combination of networks (e.g., the Internet, wide area networks, local area networks). A thin client application 210₂ can be hosted in a browser-controlled environment or coded in a browser-supported language and reliant on a common web browser to render the application executable on the client device 230.

A user 250 can use the application 210 to create a new presentation document 220, edit an existing presentation document 220, and/or view an existing presentation document 220. The application 210 receives input from the user 250, for example, text input, from one or more input devices including, for example, a keyboard, a computer mouse, a remote control. In some embodiments, the application 210 receives input from the user 250 through a Natural User Interface (NUI) which enables the user to interact with the client device 230 in a natural manner. Examples of NUI include speech recognition, touch and stylus recognition, gesture recognition both on screen and adjacent to the screen, air gestures, head and eye tracking, voice and speech, vision, touch, hover, gestures, machine intelligence, and the like.

The user input results in content 260 being added to the presentation document 220. In some embodiments, content 260 is added within a document canvas (e.g., a page in a word processing document, a spreadsheet in a spreadsheet document, a slide in an electronic presentation document) of the presentation document 220.

While creating and/or editing the presentation document 220, the system 100 can be triggered (e.g., explicitly and/or implicitly) to identify slide(s) related to a particular slide. In response to the trigger, the system 100 can identify slide(s) related to a particular slide of the electronic presentation document 220 and provide link(s) to the identified slide(s) within the particular slide.

In some embodiments, the trigger event can be inferred based upon a user's navigation to the particular slide. In some embodiments, the trigger event can be inferred based upon addition of an object to the particular slide. In some embodiments, the trigger event can be inferred based upon modification of an object of the particular slide. In some embodiment, a user can expressly request the system 100 to identify slide(s) related to the particular slide.

Referring to FIG. 1, the system 100 includes a slide analysis component 110, an identification component 120, and a linking component 130. In some embodiments, the system 100 is a component of a presentation application used to view, generate, and/or edit an electronic presentation document. In some embodiments, the system 100 is a service (e.g., cloud-based service) available to the presentation application (e.g., in a privacy-preserving manner).

The slide analysis component 110 analyzes content and/or semantic structure of a particular slide (or portion thereof) to determine information regarding the particular slide. In some embodiments, the particular slide can include one or more objects. “Object” refers to a representation of digital information that can be included in a slide. By way of explanation and not limitation, “object” can include a formula, digital ink, a diagram, a chart, a spreadsheet, a text, an image, a video, and an audio file. In some embodiments, the slide analysis component 110 can further analyze metadata associated with object(s) to determine information regarding the particular slide.

In some embodiments, the slide analysis component 110 utilizes natural language processing to determine information regarding text of the particular slide. In some embodiments, the slide analysis component 110 can analyze the particular slide and/or metadata for keyword(s), topic(s), and/or concept(s). In some embodiments, the slide analysis component 110 can perform image and/or facial recognition to determine information regarding the particular slide. In some embodiments, the slide analysis component 110 can perform speech-to-text to determine information regarding the particular slide. In some embodiments, the slide analysis component 110 can perform voice recognition to determine information regarding the particular slide.

In some embodiments, the slide analysis component 110 can further utilize information regarding a particular user (e.g., creating and/or editing the presentation) and/or a particular presenter. The information regarding the particular user and/or presenter can include profile information, for example, a role within an organizational hierarchy (e.g., manager), educational information (e.g., PhD in biology), government licensing information (e.g., medical doctor, attorney, pharmacist), educational information, skills, certifications. In some embodiments, the information regarding the particular user can focus analysis of the slide analysis component 110 in identifying relevant keyword(s), topic(s), and/or concept(s) in the particular slide.

The identification component 120 can utilize a machine learning algorithm to identify other slide(s) (e.g., of the presentation and/or stored separately) that are related to the particular slide in accordance with the determined information. In some embodiments, the machine learning algorithm calculates probabilities for each of the other slides that the slide is related to the particular slide in accordance with the determined information (e.g., analyzed content and/or semantic structure of the particular slide). Other slides with calculated probabilities greater than a threshold probability are identified as related to the particular slide. In some embodiments, the threshold probability is predefined. In some embodiments, the threshold probability is user-configured. In some embodiments, the threshold probability can be adjusted (e.g., dynamically) based upon user feedback (e.g., accepting/rejecting link(s) to identified related slide(s)).

In some embodiments, the identification component 120 employs one or more machine learning algorithms including a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an artificial neural network (ANN), and/or a Gradient Boost & Adaboost algorithm.

In some embodiments, the machine learning algorithm can apply a model is trained (e.g., learned) offline using particular slide(s) and linked related slide(s) (e.g., linked by a human user). Training can be performed in a supervised, unsupervised and/or semi-supervised manner. Related slide(s) identified and/or probabilities calculated by the algorithm can be compared with the actual (e.g., observed) with the algorithm adjusted accordingly.

In some embodiments, the identification component 120 identifies other slide(s) of the same presentation that includes the particular slide. In some embodiments, the identification component 120 identifies other slide(s) stored separately from the presentation that includes the particular slide. For example, a particular user can have one or more stored presentations that the particular user has opted-in to the system 100 accessing to identify related slide(s). In some embodiments, with the user's express consent, the identification component 120 can store a copy of the identified related slide(s) in the presentation that includes the particular slide. In some embodiments, with the user's express consent, the identification component 120 can store a reference (e.g., pointer) to the identified related slide(s) in the presentation.

The linking component 130 provides a link within the particular slide to the identified slide(s). In some embodiments, the link comprises a thumbnail of the identified slide. In some embodiments, the link comprises a visual indication (e.g., highlighting, underlining, italicizing) within the particular slide. During presentation mode, selection of the link causes a transition to the identified slide(s) (e.g., slide zoom) associated with the link.

In some embodiments, the provided link can be based upon user-configurable preferences. In some embodiments, the provided link can be based upon historical usage of the system 100 by the user. In some embodiments, the provided link can be based upon the particular slide. In some embodiments, the provided link can be based upon the identified slide.

In some embodiments, the linking component 130 provides information to the user regarding the identified related slide(s) for the user's approval. Link(s) approved by the user are stored in the particular slide with link(s) not approved by the user disregarded by the system 100 (e.g., link(s) not stored). Information regarding the user's approval and/or disapproval can be provided to the identification component 120 with the machine learning algorithm adjusted accordingly.

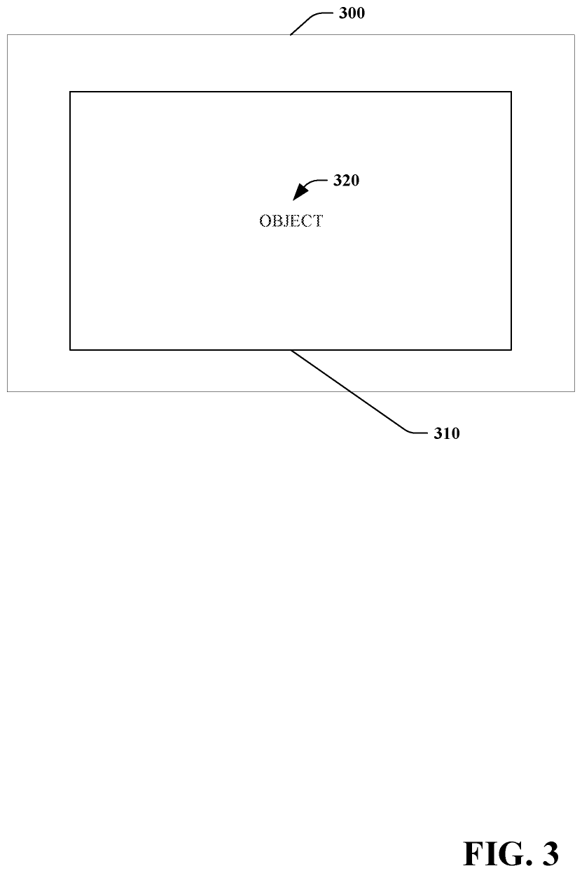

FIGS. 3-5 illustrate a scenario in which an object is analyzed and a related slide is linked to the object within a slide of a presentation. Turning to FIG. 3, an exemplary user interface 300 generated by the application 210 is illustrated. The user interface 300 includes a slide 310 comprising an object 320.

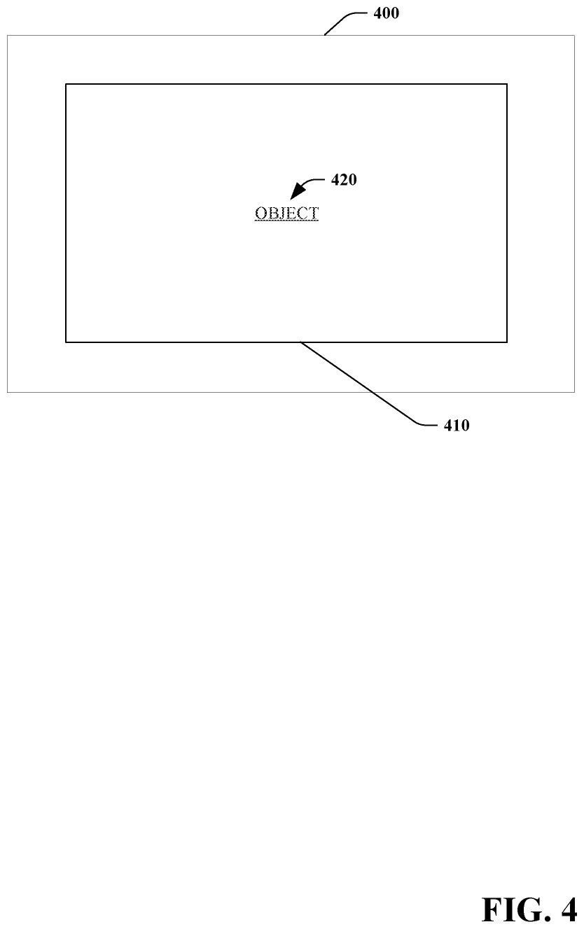

Referring to FIG. 4, an exemplary user interface 400 generated by the application 210 in accordance with information provided by the system 100 is illustrated. In response to a trigger event (e.g., user-initiated explicit or inferred), the system 100 has analyzed the slide 310 and the object 320, identified a related slide and provide a link to the related slide. The user interface 400 includes a slide 410 comprising the object with a link 420 (e.g., visually indicated by underlining of the word “OBJECT”).

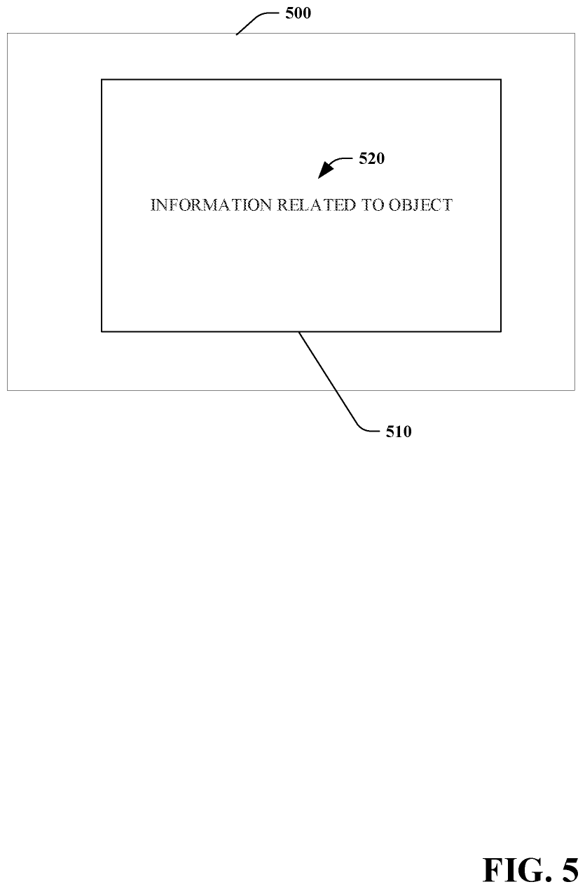

Next, turning to FIG. 5, an exemplary user interface 500 generated by the application 210 in accordance with information provided by the system 100 is illustrated. Selecting the link 420 of FIG. 4 in presentation mode transitions the presentation to related slide 510 comprising an object 520 (“information related to object”).

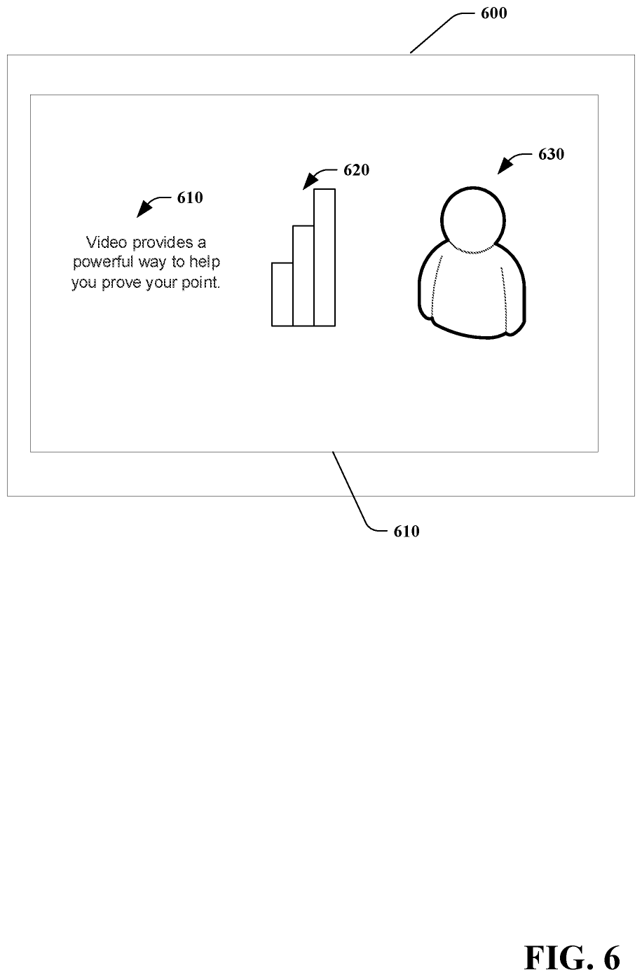

By way of example and not limitation, FIGS. 6-8 illustrate a scenario in which three objects are analyzed and a related slide is linked to each object. Turning to FIG. 6, an exemplary user interface 600 generated by the application 210 is illustrated. The user interface 600 includes a slide 610 comprising a text object 620, a chart object 630 and an image object 640.

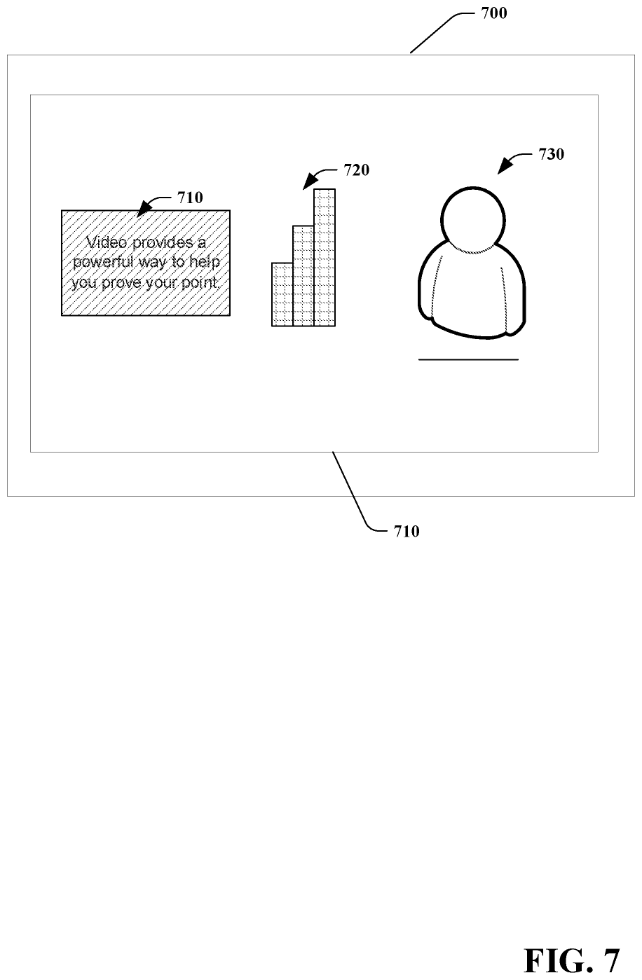

Referring to FIG. 7, an exemplary user interface 700 generated by the application 210 in accordance with information provided by the system 100 is illustrated. In response to a trigger event (e.g., explicit or inferred), the system 100 has analyzed the slide 610 including the text object 620, the chart object 630 and the image object 640, identified related slides and provided links to the related slides. The user interface 700 includes a slide 710 comprising a linked text object 720, a linked chart object 730 and a linked image object 740.

In this example, respective links for each of the objects 720, 730, 740 have been provided. The text object 720 has been diagonal lines, the chart object 730 has been crosshatched, and, the image object 730 has been underlined to indicate to the user (presenter) that a related slide is available. Selecting a particular link in presentation mode transitions the presentation to the respective related slide.

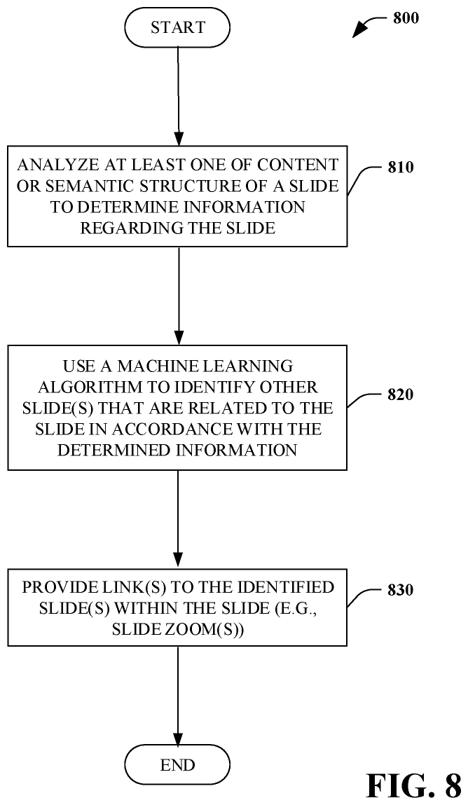

FIG. 8 illustrate an exemplary methodology relating to determining contextually-related slide(s). While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 8, a method of determining a contextually-related slide 800 is illustrated. In some embodiments, the method 800 is performed by the system 100.

At 810, at least one of content or semantic structure of a slide is analyzed to determine information regarding the slide. At 820, one or more other slides that are related to the slide are identified using a machine learning algorithm in accordance with the determined information. At 830, link(s) to the identified slide(s) are provided within the slide. In some embodiments, the link(s) can be provided as slide zoom(s) by a presentation application (e.g., PowerPoint® of Microsoft Corporation). For example, slide zoom(s) can provide smooth transitions to/from the identified slide(s).

Described herein is a system for determining a contextually-related slide, comprising: a computer comprising a processor and a memory having computer-executable instructions stored thereupon which, when executed by the processor, cause the computer to: analyze at least one of content or semantic structure of a slide to determine information regarding the slide; use a machine learning algorithm to identify one or more other slides that are related to the slide in accordance with the determined information; and provide a link to the identified one or more other slides within the slide.

The system can further include wherein the machine learning algorithm calculates probabilities, for each of the other slides, that a particular slide is related to the slide based upon the determined information regarding the slide, and, one or more other slides with calculated probabilities greater than a threshold probability are identified as related to the slide. The system can further include wherein the machine learning algorithm applies a model trained in at least one of a supervised, unsupervised, or semi-supervised manner. The system can further include wherein the model is adaptively updated based upon user feedback.

The system can further include wherein analyzing at least one of content or semantic structure of a slide to determine information regarding the slide is performed in response to an inferred trigger event. The system can further include wherein analyzing at least one of content or semantic structure of a slide to determine information regarding the slide is performed in response to a user-initiated trigger event. The system can further include wherein analyzing at least one of content or semantic structure of a slide to determine information regarding the slide comprises analyzing the slide for at least one of a keyword, a topic, or a concept.

The system can further include wherein analyzing at least one of content or semantic structure of a slide to determine information regarding the slide comprises performing at least one of voice recognition, image recognition or facial recognition. The system can further include wherein the identified one or more other slides are stored in a same presentation as the slide. The system can further include wherein the identified one or more other slides are stored in a different presentation as the slide, and copies of the identified one or more other slides are added to the presentation comprising the slide.

The system can further include wherein the machine learning algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an artificial neural network (ANN), or a Gradient Boost & Adaboost algorithm.

Described herein is a method of determining a contextually-related slide, comprising: analyzing at least one of content or semantic structure of a slide to determine information regarding the slide; using a machine learning algorithm to identify one or more other slides that are related to the slide in accordance with the determined information; and providing a link to the identified one or more other slides within the slide.

The method can further include wherein the machine learning algorithm calculates probabilities, for each of the other slides, that a particular slide is related to the slide based upon the determined information regarding the slide, and, one or more other slides with calculated probabilities greater than a threshold probability are identified as related to the slide. The method can further include wherein analyzing at least one of content or semantic structure of a slide to determine information regarding the slide is performed in response to an inferred trigger event. The method can further include wherein analyzing at least one of content or semantic structure of a slide to determine information regarding the slide comprises analyzing the slide for at least one of a keyword, a topic, or a concept.

Described herein is a computer storage media storing computer-readable instructions that when executed cause a computing device to: analyze at least one of content or semantic structure of a slide to determine information regarding the slide; use a machine learning algorithm to identify one or more other slides that are related to the slide in accordance with the determined information; and provide a link to the identified one or more other slides within the slide.

The computer storage media can further include wherein the machine learning algorithm calculates probabilities, for each of the other slides, that a particular slide is related to the slide based upon the determined information regarding the slide, and, one or more other slides with calculated probabilities greater than a threshold probability are identified as related to the slide. The computer storage media can further include wherein analyzing at least one of content or semantic structure of a slide to determine information regarding the slide is performed in response to a user-initiated trigger event. The computer storage media can further include wherein analyzing at least one of content or semantic structure of a slide to determine information regarding the slide comprises analyzing the slide for at least one of a keyword, a topic, or a concept. The computer storage media can further include wherein analyzing at least one of content or semantic structure of a slide to determine information regarding the slide comprises performing at least one of image recognition or facial recognition.

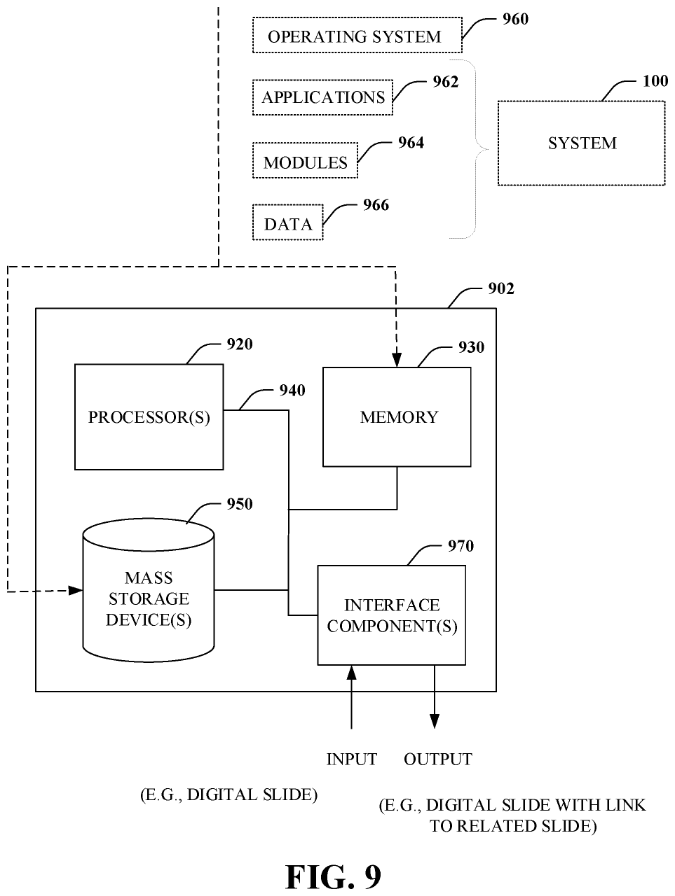

With reference to FIG. 9, illustrated is an example general-purpose computer or computing device 902 (e.g., mobile phone, desktop, laptop, tablet, watch, server, hand-held, programmable consumer or industrial electronics, set-top box, game system, compute node, etc.). For instance, the computing device 902 may be used in a system for determining a contextually-related slide 100.

The computer 902 includes one or more processor(s) 920, memory 930, system bus 940, mass storage device(s) 950, and one or more interface components 970. The system bus 940 communicatively couples at least the above system constituents. However, it is to be appreciated that in its simplest form the computer 902 can include one or more processors 920 coupled to memory 930 that execute various computer executable actions, instructions, and or components stored in memory 930. The instructions may be, for instance, instructions for implementing functionality described as being carried out by one or more components discussed above or instructions for implementing one or more of the methods described above.

The processor(s) 920 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 920 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 920 can be a graphics processor.

The computer 902 can include or otherwise interact with a variety of computer-readable media to facilitate control of the computer 902 to implement one or more aspects of the claimed subject matter. The computer-readable media can be any available media that can be accessed by the computer 902 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 902. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 930 and mass storage device(s) 950 are examples of computer-readable storage media. Depending on the exact configuration and type of computing device, memory 930 may be volatile (e.g., RAM), non-volatile (e.g., ROM, flash memory, etc.) or some combination of the two. By way of example, the basic input/output system (BIOS), including basic routines to transfer information between elements within the computer 902, such as during start-up, can be stored in nonvolatile memory, while volatile memory can act as external cache memory to facilitate processing by the processor(s) 920, among other things.

Mass storage device(s) 950 includes removable/non-removable, volatile/non-volatile computer storage media for storage of large amounts of data relative to the memory 930. For example, mass storage device(s) 950 includes, but is not limited to, one or more devices such as a magnetic or optical disk drive, floppy disk drive, flash memory, solid-state drive, or memory stick.

Memory 930 and mass storage device(s) 950 can include, or have stored therein, operating system 960, one or more applications 962, one or more program modules 964, and data 966. The operating system 960 acts to control and allocate resources of the computer 902. Applications 962 include one or both of system and application software and can exploit management of resources by the operating system 960 through program modules 964 and data 966 stored in memory 930 and/or mass storage device (s) 950 to perform one or more actions. Accordingly, applications 962 can turn a general-purpose computer 902 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 962, and include one or more modules 964 and data 966 stored in memory and/or mass storage device(s) 950 whose functionality can be realized when executed by one or more processor(s) 920.

In accordance with one particular embodiment, the processor(s) 920 can correspond to a system on a chip (SOC) or like architecture including, or in other words integrating, both hardware and software on a single integrated circuit substrate. Here, the processor(s) 920 can include one or more processors as well as memory at least similar to processor(s) 920 and memory 930, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 902 also includes one or more interface components 970 that are communicatively coupled to the system bus 940 and facilitate interaction with the computer 902. By way of example, the interface component 970 can be a port (e.g., serial, parallel, PCMCIA, USB, FireWire, etc.) or an interface card (e.g., sound, video, etc.) or the like. In one example implementation, the interface component 970 can be embodied as a user input/output interface to enable a user to enter commands and information into the computer 902, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 970 can be embodied as an output peripheral interface to supply output to displays (e.g., LCD, LED, plasma, etc.), speakers, printers, and/or other computers, among other things. Still further yet, the interface component 970 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for determining a contextually-related slide, comprising:
a computer comprising a processor and a memory having computer-executable instructions stored thereupon which, when executed by the processor, cause the computer to:
analyze at least one of content or semantic structure of a slide to determine information regarding the slide;
use a machine learning algorithm to identify one or more other slides that are related to the slide in accordance with the determined information; and
provide a link to the identified one or more other slides within the slide.

2. The system of claim 1, wherein the machine learning algorithm calculates probabilities, for each of the other slides, that a particular slide is related to the slide based upon the determined information regarding the slide, and, one or more other slides with calculated probabilities greater than a threshold probability are identified as related to the slide.

3. The system of claim 1, wherein the machine learning algorithm applies a model trained in at least one of a supervised, unsupervised, or semi-supervised manner.

4. The system of claim 3, wherein the model is adaptively updated based upon user feedback.

5. The system of claim 1, wherein analyzing at least one of content or semantic structure of a slide to determine information regarding the slide is performed in response to an inferred trigger event.

6. The system of claim 1, wherein analyzing at least one of content or semantic structure of a slide to determine information regarding the slide is performed in response to a user-initiated trigger event.

7. The system of claim 1, wherein analyzing at least one of content or semantic structure of a slide to determine information regarding the slide comprises analyzing the slide for at least one of a keyword, a topic, or a concept.

8. The system of claim 1, wherein analyzing at least one of content or semantic structure of a slide to determine information regarding the slide comprises performing at least one of voice recognition, image recognition or facial recognition.

9. The system of claim 1, wherein the identified one or more other slides are stored in a same presentation as the slide.

10. The system of claim 1, wherein the identified one or more other slides are stored in a different presentation as the slide, and copies of the identified one or more other slides are added to the presentation comprising the slide.

11. The system of claim 1, wherein the machine learning algorithm comprises at least one of a linear regression algorithm, a logistic regression algorithm, a decision tree algorithm, a support vector machine (SVM) algorithm, a Naive Bayes algorithm, a K-nearest neighbors (KNN) algorithm, a K-means algorithm, a random forest algorithm, a dimensionality reduction algorithm, an artificial neural network (ANN), or a Gradient Boost & Adaboost algorithm.

12. A method of determining a contextually-related slide, comprising:
analyzing at least one of content or semantic structure of a slide to determine information regarding the slide;
using a machine learning algorithm to identify one or more other slides that are related to the slide in accordance with the determined information; and
providing a link to the identified one or more other slides within the slide.

13. The method of claim 12, wherein the machine learning algorithm calculates probabilities, for each of the other slides, that a particular slide is related to the slide based upon the determined information regarding the slide, and, one or more other slides with calculated probabilities greater than a threshold probability are identified as related to the slide.

14. The method of claim 12, wherein analyzing at least one of content or semantic structure of a slide to determine information regarding the slide is performed in response to an inferred trigger event.

15. The method of claim 12, wherein analyzing at least one of content or semantic structure of a slide to determine information regarding the slide comprises analyzing the slide for at least one of a keyword, a topic, or a concept.

16. A computer storage media storing computer-readable instructions that when executed cause a computing device to:
analyze at least one of content or semantic structure of a slide to determine information regarding the slide;
use a machine learning algorithm to identify one or more other slides that are related to the slide in accordance with the determined information; and
provide a link to the identified one or more other slides within the slide.

17. The computer storage media claim 16, wherein the machine learning algorithm calculates probabilities, for each of the other slides, that a particular slide is related to the slide based upon the determined information regarding the slide, and, one or more other slides with calculated probabilities greater than a threshold probability are identified as related to the slide.

18. The computer storage media of claim 16, wherein analyzing at least one of content or semantic structure of a slide to determine information regarding the slide is performed in response to a user-initiated trigger event.

19. The computer storage media of claim 16, wherein analyzing at least one of content or semantic structure of a slide to determine information regarding the slide comprises analyzing the slide for at least one of a keyword, a topic, or a concept.

20. The computer storage media of claim 16, wherein analyzing at least one of content or semantic structure of a slide to determine information regarding the slide comprises performing at least one of image recognition or facial recognition.
